(19) United States
(12) Patent Application Publication
(10) Pub. No.: US 2004/0012128 A1
(43) Pub. Date: Jan. 22, 2004

(54) Method for manufacturing containers for growing plants and container produced with such method

(76) Inventor: Giovanni F Masello, San Vito Di Leguzzano (IT)

Correspondence Address: COLEMAN SUDOL SAPONE, P.C., 714 COLORADO AVENUE, BRIDGE PORT, CT, 06605-1601, US

(21) Appl. No.: 10/416,820

(22) PCT Filed: Nov. 29, 2001
(86) PCT No.: PCT/EP01/13931

(30) Foreign Application Priority Data
Dec. 1, 2000 (IT) VI2000A000266

(51) Int. Cl. C04B 33/32; C04B 33/36; C04B 35/64

(52) U.S. Cl. 264/670

(57) ABSTRACT

A method for manufacturing containers for growing plants, comprising an initial step of reducing plastics and fired clay to granules and a final step of releasing the containers from molds. The method includes, in order of sequence, the intermediate steps of preparing a mixture of the granules, introducing the mixture into the molds, heating the mixture until the melting temperature of the material is approximately reached, holding the mixture at that temperature, and cooling the mixture. A container produced with the method includes uniformly distributed fired clay granules and reticular formations of plastics that mutually bind the granules. The invention overcomes the drawbacks of the prior art, by providing containers that combine the best characteristics of earthenware and plastic containers, respectively.

The present invention relates to a method for manufacturing containers for growing plants and to a container produced with such method, particularly but not exclusively useful in the field of the manufacture of vases of any shape for growing ornamental plants but also fruit-bearing plants.

The prior art is constituted by frustum-shaped and tray-like vases made of earthenware or plastics. The former are manufactured according to traditional methods which are widely known and used in the field of clay product. manufacturing. The latter are generally manufactured by means of processes for the injection-molding of plastics. Earthenware vases have many advantageous features, such as:

porosity, which allows natural transpiration, through the structure of the vase, of the vegetative system of the plant and also prevents the stagnation of water in the soil in which the plant is bedded;

surface shades of color and defects which make each vase unique.

With respect to conventional vases, plastic ones distinguish themselves for the following features:

better elastic properties and considerable resistance to impacts;

effective resistance to frost;

absence of efflorescences on the external surface;

a larger number of replantings can be performed using the same vase.

The main drawback of this state of the art is that earthenware vases lack the advantageous features of plastic vases and vice versa.

The aim of the present invention is to overcome the drawbacks of the cited prior art, by providing a method for manufacturing containers for growing plants, and a container which can be produced with the method, that effectively combine the above-described advantageous features of both earthenware vases and plastic vases.

An object of the invention is to provide a method having a small number of simple operations, which can be easily industrialized, and is such as to entail low manufacturing costs, so as to make it economically advantageous to manufacture these vases.

Another object of the present invention is to provide a vase which is also composed of recycled materials, so as to provide a considerable benefit to the environment and reduce manufacturing costs.

This aim, these objects and others which will become better apparent hereinafter are achieved by a method for manufacturing containers for growing plants and by a container which can be produced with such method, according to the accompanying main process and product claims, respectively.

The method for manufacturing containers for growing plants comprises an initial step of reducing plastics and fired clay to granules. The plastics, that is preferably used, is mainly constituted by polyethylene of any density, either virgin or recycled from previous industrial processes. The average size of the granule obtained as a consequence of polyethylene reduction is approximately equal to 500 microns or in any case between 100 and 900 microns in order to ensure its uniform melting. The average size of the granules of fired clay may be any.

The method according to the invention comprises intermediate steps, described hereafter in order of sequence. First of all, there is a step of preparing a mixture formed by the polyethylene granules and the clay granules.

The mixture is prepared dry, by joining the polyethylene to the clay granules according to proportions derived from the characteristics to be obtained in the finished product.

By privileging the amount of clay in the mixture, the porosity of the vase increases, while its elasticity and resistance to impacts decrease. Vice versa, by increasing the amount of polyethylene these last properties are improved to the detriment of porosity and final aesthetic effect. In any case, as an approximation, the percentage of polyethylene in the mixture is between 50 and 70% of total weight. The remaining part is constituted by the clay.

That preparation step is followed by a step of introducing the mixture in adapted molds.

That introduction step is followed by a step of gradually heating the mixture until the melting temperature of the polyethylene is reached.

As an approximation, the temperature is between 150 and 400° C. Preferably, a temperature between 200 and 300° C. is reached.

The variation of the temperature within such a wide range is due to the fact that the polyethylene is intimately mixed with the clay and therefore does not behave as in the pure state when heated.

The Applicant has in fact found that with 50% polyethylene in the mixture the melting temperature is approximately 250° C., while with 70% polyethylene the temperature rises to 280° C.

The heating step is followed by a step in which the mixture is held at the so-called melting temperature for a heating period which is sufficient to allow the melted polyethylene to diffuse in the intergranular spaces and penetrate, albeit to a limited extent, in the clay granules. This penetration is meant mainly to bind the granules to the polyethylene matrix. The penetration is limited, so as to avoid compromising the surface porosity of the granules. The percentage of polyethylene in the mixture influences the heating time as well. The Applicant has found that as the polyethylene percentage increases, the heating time decreases. With 50% polyethylene, the heating time is approximately 20 minutes; with 70% polyethylene it is approximately 15 minutes.

The step of holding the mixture at the melting temperature is followed by a cooling step. The cooling step lasts for a cooling time which is sufficient to fix the reticulation of the polyethylene around the clay granules and to enable the containers thus formed for the next step. Again, the Applicant has found that this cooling time depends on the percentage of polyethylene and substantially decreases as this percentage increases. With 50% polyethylene in the mixture, the cooling time is approximately 20 minutes; with 70% polyethylene it is approximately 15 minutes. Cooling occurs in air without adopting particular procedural refinements. Once the containers have reached ambient temperature, they are released from the corresponding molds that contain them.

The container produced by this method is particular in. that it includes granules of fired clay which are uniformly distributed and reticulate formations of plastics, preferably polyethylene, which bind together the clay granules.

As clearly evident, the method and the vase achieve the intended aim and objects.

The method in fact comprises a reduced number of simple operations, so that it can be industrialized easily, with consequent low production costs.

The resulting vase combines in the best way the advantageous features of earthenware vases and plastic vases.

The advantageous properties of the former are in fact given by the uniformly distributed fired clay granules, while the advantageous properties of the latter are given by the plastics that acts as an intergranular binding agent.

The method and the container according to the invention are susceptible of numerous modifications and variations, within the scope of the appended claims.

All the details may be replaced with other technically equivalent elements.

In practice, the materials employed may be any according to requirements.

1. A method for manufacturing containers for growing plants, comprising an initial step of reducing plastics and fired clay to granules and a final step of releasing said containers from molds, characterized in that it comprises, in order of sequence, the intermediate steps of:
preparing a mixture of said granules of said plastics. and of said clay;
introducing said mixture in said molds;
heating said mixture until the melting temperature of said material is approximately reached;
holding said mixture at said temperature for a heating time sufficient to allow said melted material to diffuse and penetrate, at least to a limited extent, in said granules of said clay;
cooling said mixture for a cooling time which is sufficient to fix the reticulation of said material around said granules of said clay and to enable said containers for said release.

2. The method according to claim 1, characterized in that the average size of the plastics granules is between 100 and 900 microns.

3. The method according to one or more of the preceding claims, characterized in that said preparation of said mixture occurs in dry conditions.

4. The method according to one or more of the preceding claims, characterized in that the percentage by weight of plastics on the total of said mixture is between 50 and 70%.

5. The method according to one or more of the preceding claims, characterized in that said heating is gradual.

6. The method according to one or more of the preceding claims, characterized in that said melting temperature is between 200 and 300° C.

7. The method according to one or more of the preceding claims, characterized in that said heating time decreases as said weight percentage of said plastics in said mixture increases, in that a minimum percentage corresponds to a maximum heating time and vice versa, said heating time being between 15 and 20 minutes.

8. The method according to one or more of the preceding claims, characterized in that said cooling time decreases as said weight percentage of said plastics in said mixture increases, in that a minimum percentage corresponds to a maximum heating time and vice versa, said cooling time being between 15 and 20 minutes.

9. The method according to one or more of the preceding claims, characterized in that said plastics comprises mostly virgin and/or recycled polyethylene of any density.

10. A container produced according to the method, characterized in that it comprises uniformly distributed granules of fired clay and reticulate formations of plastics that bind said granules together.
